(19) United States
(12) Patent Application Publication
(10) Pub. No.: US 2007/0021550 A1
(43) Pub. Date: Jan. 25, 2007

(54) Fluoropolymer low reflecting layers for plastic lenses and devices

(76) Inventors: Satoko Iwato, Tokyo (JP); Mureo Kaku, Tochigi (JP); Andrew Edward Feiring, Wilmington, DE (US); Ronald Earl Uschold, West Chester, PA (US); Robert Clayton Wheland, Wilmington, DE (US)

Correspondence Address: Dalickas, Gail A;E.I. Dupont De Nemours and Company, 4417 Lancaster Pike, Wilmington, DE, 19805, US

(21) Appl. No.: 10/575,392

(22) PCT Filed: Oct. 7, 2003
(86) PCT No.: PCT/US03/32090

§ 371 Date: Apr. 26, 2006

(51) Int. Cl. C08L 27/12; C08F 214/18; B32B 27/00

(52) U.S. Cl. 524/544; 526/250; 526/255; 428/421; 428/336

(57) ABSTRACT

A one layer coating system has been developed for plastic substrates. The one coating system low reflective layer consists of VF₂/TFE/HFP, VF₂/HFP, VF₂/TFE/PMVE.

### FIELD OF INVENTION

The present invention relates to fluoropolymer coated plastics. More specifically, it relates to fluoropolymer coated plastics having good adhesion, low reflective properties, and water and oil repellency.

### TECHNICAL BACKGROUND

Much work has been done concerning low reflective plastics, particularly for plastic lenses and optical devices. One method used is vapor disposition of oxidized metal on the surface of the plastic. However, this method uses a batch process and when the substrate is large, the productivity becomes low. Another way is to apply a coating of fluoropolymer solutions. The coating is done by a dipping process and is applicable for large substrates with high productivity. Though fluoropolymers have low reflective indexes, they also have very poor adhesion with plastic substrates. Improvement in the adhesion between fluoropolymers and substrate plastics has been long sought. The purpose of this invention is to provide the technology for low reflective index and good adhesion using fluoropolymer solutions.

### SUMMARY OF THE INVENTION

The one layer coating system provided by the present invention consists of a fluorinated copolymer having the formula
VF₂/TFE/HFP
wherein the molar ratio of tetrafluoroethylene (TFE) to Hexafluoropropylene (HFP) is between 0.1 and 1.9, and the VF₂ content is 47 to 60 mole %. Preferably the VF₂ content is 50-60 mole %. More preferred is where the molar ratio of TFE to HFP is between 0.9 and 1.9, and the VF₂ content is preferably 47 to 60 mole % for polymethylmethacrylate (PMMA) substrates and 47 to 50 mole % for polycarbonate (PC), polyethyleneterephthalate (PET), polysulfone (PS) and glass substrates.

Also preferred is where the VF₂ content is greater than 50% to 60 mole %; more preferred is where the substrate is PMMA, PC, PET, PS or glass.

A one layer coating system is also provided by the present invention comprising a fluorinated copolymer having the formula
VF₂/HFP
wherein the VF₂ content is about 40-80%. Preferably, the VF₂ content is about 40-50 mole % and the substrate is PMMA. Also preferably, the VF₂ content is about 70-80 mole % and the substrate is glass.

A one layer coating system is also provided by the present invention comprising a fluorinated copolymer having the formula
VF₂/TFE/PMVE
wherein the VF₂ content is about 18-60 mole % and the TFE/PMVE mole ratio is 0.1-1.9. Preferably the VF₂ content is about 30-35 mole %, the TFE/PMVE mole ratio is about 0.2-0.3 and the substrate is PMMA.

In the one layer coating systems of the present invention, the thickness of the coating is preferably between about 10 and 1000 nm, more preferably, between about 30 and 120 nm, and most preferably between about 70 and 120 nm.

### DETAILED DESCRIPTION OF THE INVENTION

One layer systems have been found that afford low reflection coatings on optically clear plastic substrates with good adhesion. Preferred substrates are PMMA, PC, PET, and PS, and glass.

The one layer coating system provided by the present invention consists of a fluorinated copolymer having the formula
VF₂/TFE/HFP
wherein the molar ratio of TFE to HFP is between 0.1 and 1.9 and the VF₂ content is 47 to 60 mole %, preferably 50 to 60 mole %. These compositions balance the high fluorine content needed for low reflection, the high HFP content needed for optical clarity and a sufficient VF₂ content to afford good adhesion to the substrate. More preferred is where the molar ratio of TFE to HFP is between 0.9 and 1.9, and the VF₂ content is preferably 47 to 60 mole % for PMMA substrates and 47 to 50 mole % for PC, PET, and glass substrates.

Another embodiment of the one layer system comprises a fluorinated copolymer having the formula
VF₂/HFP
wherein the VF₂ is about 40-80 mole %. The system is comprised essentially of the two monomers with little or no other monomers incorporated. Preferably, the VF₂ content is about 40-50% and the substrate is PMMA. Also preferably, the VF₂ content is about 70-80% and the substrate is glass.

Another embodiment of the one layer system comprises a fluorinated copolymer having the formula
VF₂/TFE/PMVE
wherein the VF₂ content is about 18-60 mole % and the TFE/PMVE mole ratio is 0.1-1.9. Preferably the VF₂ content is about 30-35 mole %, the TFE/PMVE mole ratio is about 0.2-0.3 and the substrate is PMMA.

In the one layer coating systems of the present invention, the coating needs to be thicker than about 10 nm in order to observe a significant reduction in reflectivity. While thicknesses greater than 10 nm work well, practical problems eventually arise as the coating is made thicker. For example, above about 1000 nm, thickness variation can become a problem, and, if the coating polymer is expensive, economics start to be prohibitive. Thus, in the one layer coating system of the present invention, the thickness of the coating is preferably between about 10 and 1000 nm, more preferably, between about 300 and 120 nm, most preferably, between about 70 and 120 nm.

The coatings can be prepared using any method known in the art. Suitable solvents used for preparing the coatings are those which dissolve the coating composition but are inert to the substrate being coated. Preferred solvents include fluorosolvents such as Fluorinert® (3M Electronic Materials, St. Paul, Minn.), Vertrel®. (E. I. DuPont de Nemours, Wilmington, Del.) or Novec® (3M Electronic Materials, St. Paul, Minn.), and ketone solvents such as methyl isobutyl ketone or acetone, isobutyl acetate, and combination of two or more thereof.

Other ingredients may be added to any or all of the compositions described above. In addition to the components discussed above, the compositions of this invention may contain additives commonly employed with synthetic polymers, such as colorants, antioxidants, tougheners, nucleating agents, ultraviolet light stabilizers, heat stabilizers, co-agents, crosslinking agents, and the like. These ingredients are each typically used in proportions of less than 1%.

The following non-limiting Examples are meant to illustrate the invention but are not intended to limit it in any way.

### Materials and Methods

The following definitions are used herein and should be referred to for claim interpretation.
APS—Ammonium persulfate
HFIB—Hexafluoroisobutylene, (CF₃)₂C═CH₂
HFP—Hexafluoropropylene, CF₂═CF—CF₃
PC—Polycarbonate
PET—Polyethyleneterephthalate
PMMA—Polymethylmethacrylate
PMVE—Perfluoromethylvinylether
PVOH—Polyvinyl alcohol
PS—Polysulfone
Teflon® AF—TFE/Perfluoro-2,2-dimethyldioxole copolymer
TFE—Tetrafluoroethylene, CF₂═CF₂
VAc—Vinyl acetate, CH₃—C(O)—OCH═CH₂
VF—Vinyl fluoride, CH₂═CHF
VF₂—Vinylidene fluoride, CF₂═CH₂
   Unless otherwise indicated, the following test methods were used:
   Method of Measuring Transmission

Light transmission was measured at 500 nm using a Shimadzu #UV-3100 Spectrometer. This machine measures a continuous comparison of a split beam, part of which passes through the sample.

Adhesion Test Method

A tool with 10 razor blades separated by a distance of 1 mm was used to cut the coating down to the plastic substrate, drawing the razor blade tool first in one direction and then a second time in a perpendicular direction. This cuts 100 crosshatched squares. Scotch tape was applied to the crosshatched area with moderate pressure and pulled off rapidly. Adhesion is scored as the number of squares out of 100 still attached to the substrate.

Unless otherwise indicated, all other polymers and monomers were obtained are commercially available.

VF2/TFE/HFP terpolymers and TFE/HFP dipolymers having HFP contents in excess of 30 mole % are perhaps most easily made by polymerization at 14,000 psi and 200-400° C. as described in U.S. Pat. Nos. 5,478,905 and 5,637,663. VF2/TFE/HFP terpolymers and the TFE/HFP dipolymers having lower HFP contents as well as VF2/TFE/PMVE terpolymers can be run under ordinary emulsion and bulk polymerization methods known in the art, see for instance Encyclopedia of Polymer Science and Engineering, 1989, Vol. 16, pg. 601-603 and Vol. 7, pg. 257-269, John Wiley & Sons. Non-crystalline compositions showing good optical clarity and easy solution coatability were then selected for this invention.

### EXAMPLES

### Examples 1-9

### Comparative Examples 1-3

### One Coat Poly(VF₂/TFE/HFP) on PMMA Preferred Thickness Range

Solutions, 2 wt % poly(VF₂/TFE/HFP) in Fluorinert® FC-75, were made by agitating chunks of the polymer with solvent for several days at room temperature. PMMA plates measuring 2.5 cm by 5.0 cm by 3 mm thick were used for testing. The PMMA plates were coated by lowering the plates into the polymer solution at a rate of 300 mm/min. and then, 30 seconds later, raising the plates back out of the solution at 2.5 to 1000 mm/min. After 5-10 minutes air drying, the plates were dried horizontally for 60 minutes in a 100° C. air oven. Examples are in order of increasing coating thickness.

TABLE 1
Single Coat of 18.7/43.3/38.0 mole % Poly(VF₂/TFE/HFP) on PMMA

| | Thickness (nm) | Transmittance (%) |
|---|---|---|
| Comp. #1 | Uncoated PMMA control | 92.1 |
| Comp. #2 | 5.0 | 92.8 |
| Example #1 | 20.0 | 94.5 |
| Example #2 | 70.6 | 96.7 |
| Example #3 | 76.3 | 97.7 |
| Example #4 | 90.2 | 98.0 |
| Example #5 | 106.2 | 96.6 |
| Example #6 | 133.3 | 93.2 |
| Example #7 | 209.2 | 94.6 |
| Example #8 | 394.7 | 95.2 |
| Example #9 | 572.1 | 94.4 |
| Comp. #3 | 2000 | not uniform |

Uncoated PMMA showed 92.1% transmission. Coatings thicker than 20.0 nm and thinner than 1000 nm gave improved transmission (>93%) relative to uncoated PMMA. The highest transmissions (>96%) were shown by coatings ˜30 to 120 nm thick.

### Examples 10-13

### Comparative Examples 4-5

### One Coat Poly(VF₂/TFE/HFP) on PMMA Preferred VF₂ Content

Polymer films were prepared as in Examples 1 to 9. Transmittance and adhesion were measured with the results shown in Table 2 below which lists Examples and Comparative Examples in order of increasing VF₂ content.

TABLE 2
Adhesion by Standard Tape Pull Test
Single Coat Poly(VF₂/TFE/HFP) on PMMA

| | Mole % | Adhesion | Transmittance |
|---|---|---|---|
| | VF₂/TFE/HFP | (/100) | (%) |
| Comp. #1 | Uncoated PMMA | — | 92.1 |
| | control | | |
| Comp. #4 | 0/57/43 Control | 0 | 97.2 |
| Comp. #5 | 7.8/60.3/31.8 | 64 | 97.5 |
| Example | 12.6/51.3/36.1 | 96 | 97.2 |
| #10 | | | |
| Example | 18.7/43.3/38.0 | 99 | 97.9 |
| #11 | | | |
| Example | 25.2/42.9/31.9 | 100 | 95.1 |
| #12 | | | |
| Example | 37.4/28.9/33.7 | 100 | 96.0 |
| #13 | | | |

Simultaneous good adhesion (>96/100) and improved transmission (>97%) relative to uncoated PMMA were observed for VF₂/TFE/HFP polymers with 12 to 50 mole % VF₂.

### Example 14

A solution, 2 wt % poly(VF₂/TFE/HFP=46.9/13.5/39.6 mole %) in Vertrel® XF, were made by agitating chunks of the polymer with solvent for several days at room temperature. PMMA plates measuring 2.5 cm by 5.0 cm by 3 mm thick were used for testing. The PMMA plates were coated by lowering the plates into the polymer solution at a rate of 300 mm/min. and then, 30 seconds later, raising the plates back our of the solution at 50 mm/min. After 5-10 minutes air drying, the plates were dried horizontally for 60 minutes in a 100° C. air oven. Transmittance and adhesion were measured with the results shown the table below which lists Examples.

TABLE 3
Single Coat of 46.9/13.5/39.6 mole % Poly(VF₂/TFE/HFP) on PMMA

| | Mole %'s | Adhesion | Transmittance |
|---|---|---|---|
| | VF₂TFE/HFP | (/100) | (%) |
| Example | 46.9/13.5/39.6 | 100 | 97.4 |
| #14B | | | |
| Comp. #1 | Uncoated PMMA control | — | 92.1 |

Simultaneous good adhesion (100/100) and improved transmission (>97%) relative to uncoated PMMA were observed for VF₂/TFE/HFP = 46.9/13.5/39.6 mole % terpolymer.

### Examples 15 to 17

### Comparative Examples 6-9

### One Coat Poly(VF₂/TFE/HFP) on Polycarbonate Preferred VF₂ Content

Poly(VF₂/TFE/HFP) terpolymer samples of different VF₂ content were coated on polycarbonate (PC) sheet using the method of Example 14. The polycarbonate was manufactured by Kyoto-Jushi Seiko Co., Ltd. The polycarbonate sheets measured 2.5 cm×5.0 cm by 3 mm thick.

Transmission and adhesion were measured with the results shown in Table 4 below which lists Examples and Comparative Examples in order of increasing VF₂ content.

TABLE 4
Single Poly(VF₂/TFE/HFP) Coat on PC

| | Mole %'s | Adhesion | Transmittance |
|---|---|---|---|
| | VF₂/TFE/HFP | (/100) | (%) |
| Comp. #6 | Uncoated PC Control | — | 87.2 |
| Comp. #7 | 0/57/43 | 0 | 95.2 |
| Comp. #8 | 7.8/60.3/31.8 | 0 | 90.5 |
| Comp. #9 | 12.6/51.3/36.1 | 53 | 94.7 |
| Example | 18.7/43.3/38.0 | 70 | 94.0 |
| #15 | | | |
| Example | 25.2/42.9/31.9 | 100 | 92.0 |
| #16 | | | |
| Example | 37.4/28.9/33.7 | 100 | 93.8 |
| #17 | | | |

VF₂ contents between about 18 and 40 mole % give improved adhesion (>70/100) relative to HFP/TFE copolymer (0/100) and improved transmission (>92%) relative to uncoated PC (87.2%).

### Example 18

### Comparative Examples 10-11

### One Coat Poly(VF2/TFE/HFP) on PET

Coatings were prepared as in Examples 1 to 9. PET sheets measuring 2.5 by 5.0 cm by 0.12 mm thick were used as substrate. Transmittance and adhesion were measured with the results shown in the table below which lists Examples and Comparative Examples.

TABLE 5
Poly(VF2/TFE/HFP) Coat on PET

| | Mole %'s | Adhesion | Transmittance |
|---|---|---|---|
| | VF2/TFE/HFP | (/100) | (%) |
| Comp. #15 | 0 | — | 85.0 |
| Comp. #11 | 0/57/43 | 2 | 96.0 |
| Example #18 | 18.7/43.3/38.0 | 99 | 96.0 |

Uncoated PET showed 85.0% transmission. Simultaneous good adhesion (>99/100) and improved transmission (>96%) relative to uncoated PET were observed.

### Example 19

### Comparative Example 12-13

### One Coat Poly(VF2/TFE/HFP) on Polysulfone

Coatings were prepared as in Example 1 to 9. Polysulfone sheets measuring 2.5×5.0 cm by 0.05 mm thick were as substrate.

Transmittance and adhesion results are shown in the table below which lists Examples and Comparative Examples.

TABLE 6
Single Coat Poly(VF2/TFE/HFP) on Polysulfone

| | Mole %'s | | |
|---|---|---|---|
| | VF2/TFE/HFP | Adhesion (/100) | Transmittance (%) |
| Comp. #12 | Uncoated PS | — | 88.5 |
| Comp. #13 | 0/57/43 | 97 | 98.2 |
| Example | 18.7/43.3/38.0 | 100 | 95.0 |
| #19 | | | |

Uncoated polysulfone showed 88.5% transmittance. Simultaneous good adhesion (>97/100) and improved transmission (>95%) relative to uncoated polysulfone (88.5%) were observed.

### Examples 20-26

### Comparative Examples 20-23

Solutions of 2.5 wt % poly(VF2/TFE/HFP) in Novec® HFE-7100 (3M Electronic Materials, St. Paul, Minn.) and poly(TFE/HFP) in Fluorinert® (3M Electronic Materials, St. Paul, Minn.) FC-75, were made by agitating chunks of the polymer with solvent for several days at room temperature. PMMA and PC plates measuring 2.5 cm by 5.0 cm by 3 mm thick, PET films measuring 2.5 cm by 5.0 cm by 120 micron meter thick and glass plates 2.5 cm by 5.0 cm by 1 mm thick were used for testing. The plates were coated by lowering the plates into the polymer solution at a rate of 300 mm/min. and then, 30 seconds later, raising the plates back out of the solution at 125 mm/min. After 5-10 minutes air drying, the plates were dried for 10 minutes in an air oven. The temperature was 100° C. for PMMA, 120° C. for PC and 300° C. for glass plates. The PET films were dried for 60 minutes in a 100° C. air oven. Transmittance, adhesion and coating thickness were measured with the results shown in Table 7.

TABLE 7

| | Example | Example | | Example | Example | |
|---|---|---|---|---|---|---|
| | #20 | #21 | Example #22 | #23 | #24 | Example #25 |
| VF2 (mol %) | 48 | 50 | 52 | 57 | 50 | 50 |
| HFP (mol %) | 45 | 23 | 22 | 34 | 23 | 23 |
| TFE (mol %) | 7 | 27 | 26 | 9 | 27 | 27 |
| Substrate | PMMA | PMMA | PMMA | PMMA | PC | PET |
| Thickness | 90 | 90 | 90 | 90 | 90 | 90 |
| (nm) | | | | | | |
| Adhesion | 100 | 100 | 100 | 100 | 100 | 100 |
| (/100) | | | | | | |
| Transmittance(%) | 97 | 98 | 97 | 97 | 95 | 97 |
| | Example | Comp. | | Comp. | | |
| | #26 | #20 | Comp. #21 | #22 | Comp. #23 | Comp. #24 |
| VF2 (mol %) | 50 | — | — | — | — | 0 |
| HFP (mol %) | 23 | — | — | — | — | 43 |
| TFE (mol %) | 27 | — | — | — | — | 57 |
| Substrate | Glass | PMMA | PC | PET | Glass | PMMA |
| Thickness | 90 | Uncoated | Uncoated | Uncoated | Uncoated | 90 |
| (nm) | | | | | | |
| Adhesion | 100 | — | — | — | — | 0 |
| (/100) | | | | | | |
| Transmittance(%) | 96 | 92 | 87 | 90 | 90 | 97 |

Simultaneous good adhesion (>96/100) and improved transmittance (>95%) relative to uncoated substrates were observed for VF2/TFE/HFP polymers with 40 to 60 mole % VF2.

### Examples 27-28

Solutions, 2.5 wt % poly(VF2/HFP=43/57 mole %) in Vertrel® XF (E. I. DuPont de Nemours, Wilmington, Del.) and poly(VF2/HFP=78/22 mole %) in MIBK, were made by agitating chunks of the polymer with solvent for several days at room temperature. PMMA plates measuring 2.5 cm by 5.0 cm by 3 mm thick and glass plates 2.5 cm by 5.0 cm by 1 mm thick were used for testing. Polymer films were prepared as in Examples 49 to 55 with a thickness of 90 nm Lifting up speed was 200 mm/min. Transmittance and adhesion were measured with the results shown in Table 8.

TABLE 8

| | Example #27 | Example #28 |
|---|---|---|
| VF2 (mol %) | 43 | 78 |
| HFP (mol %) | 57 | 22 |
| Substrate | PMMA | Glass |
| Adhesion (/100) | 100 | 100 |
| Transmittance (%) | 95 | 95 |

Simultaneous good adhesion (>96/100) and improved transmittance (>95%) relative to uncoated PMMA and glass were observed for VF2/HFP polymers with 40 to 80 mole % VF2.

### Example 29

Solutions, 3 wt % poly(VF2/TFE/PMVE=32/15/53 mole %) in Novec® HFE-7200 (3M Electronic Materials, St. Paul, Minn.) were made by agitating chunks of the polymer with solvent for several days at room temperature. PMMA plates measuring 2.5 cm by 5.0 cm by 3 mm thick were used for testing. Polymer films were prepared as in Examples 1 to 7. Lifting up speed was 75 mm/min. Transmittance and adhesion were measured with the results shown in Table 9.

TABLE 9

| | Example #28 |
|---|---|
| VF2 (mol %) | 32 |
| TFE (mol %) | 15 |
| PMVE (mol %) | 53 |
| Substrate | PMMA |
| Adhesion (/100) | 100 |
| Transmittance (%) | 98 |

Simultaneous good adhesion (>96/100) and improved transmittance (>95%) relative to uncoated PMMA were observed.

What is claimed is:

1. A one layer coating system for coating a substrate comprising a fluorinated copolymer having the formula
VF₂/TFE/HFP
wherein the molar ratio of TFE to HFP is between 0.1 and 1.9 and the VF₂ content is 47-60%.

2. The coating system of claim 1 wherein the VF₂ content is greater than 50% to 60 mole %.

3. The coating system of claim 2 wherein the substrate is selected from the group consisting of PMMA, PC, PET, PS and glass.

4. The coating system of claim 1 wherein the VF₂ content is 47 to 60 mole %, the molar ratio of TFE to HFP is between 0.1 and 1.9, and the substrate is PMMA.

5. The coating system of claim 1 wherein the VF₂ content is 47 to 50 mole %, the molar ratio of TFE to HFP is between 0.9 and 1.9, and the substrate is selected from the group consisting of PET, PC and glass.

6. The coating of claim 1 wherein the thickness of the coating is between 10 nm and 1000 nm.

7. The coating of claim 6 wherein the thickness of the coating is between 70 nm and 120 nm

8. A one layer coating system for coating a substrate consisting essentially of a fluorinated copolymer having the formula
VF₂/HFP
wherein the VF₂ content is about 40-80%.

9. The coating system of claim 8 wherein the VF₂ content is about 40-50% and the substrate is PMMA.

10. The coating system of claim 8 wherein the VF₂ content is about 70-80% and the substrate is glass.

11. The coating of claim 8 wherein the thickness of the coating is between 10 nm and 1000 nm.

12. The coating of claim 11 wherein the thickness of the coating is between 70 nm and 120 nm.

13. A one layer coating system for coating a substrate comprising a fluorinated copolymer having the formula
VF2/TFE/PMVE
wherein the VF₂ content is about 18-60 mole % and the TFE/PMVE mole ratio is about 0.1-1.9.

14. The coating system of claim 13 wherein the VF₂ content is about 30-35 mole %, the TFE/PMVE mole ratio is about 0.2-0.3 and the substrate is PMMA.

15. The coating of claim 13 wherein the thickness of the coating is between 10 nm and 1000 nm.

16. The coating of claim 15 wherein the thickness of the coating is between 70 nm and 120 nm.
